(19) United States
(12) Patent Application Publication
(10) Pub. No.: US 2005/0287377 A1
(43) Pub. Date: Dec. 29, 2005

(54) Method for making layers and wiring board made thereby

(75) Inventor: Kenji Wada, Fujimi-machi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/138,434

(22) Filed: May 27, 2005

(30) Foreign Application Priority Data
Jun. 28, 2004 (JP) 2004-189871

(51) Int. Cl. B05D 7/00; F16L 11/00; B05D 1/36

(52) U.S. Cl. 428/458; 427/402; 428/901

(57) ABSTRACT

A method for making layers includes (A) applying or supplying a liquid intermediate material on a first layer composed of a first insulating resin to form an intermediate material layer on the first layer; (B) applying or supplying a liquid conductive material containing a first metal on the intermediate material layer to form a conductive material layer on the intermediate material layer; and (C) activating the intermediate material layer and the conductive material layer to form an intermediate layer and a conductive layer on the intermediate layer. The liquid intermediate material contains a precursor of a second insulating resin and fine particles of a second metal.

### BACKGROUND OF THE INVENTION

1. Technical Field

The present invention relates to methods for making layers and wiring boards. It particularly relates to methods suitable for making conductive layers by inkjet techniques and wiring boards made by these methods.

2. Related Art

Inkjet techniques of forming metal wiring are widely known in the art (for example, refer to Japanese Unexamined Patent Application Publication No. 2004-6578).

Green conductive material layers prepared by depositing conductive materials on insulating layers by printing techniques such as inkjet techniques sometimes do not sufficiently bond to the underlying insulating layers. Thus, when the green conductive material layers are baked to form target conductive layers, gaps will be generated between the insulating layers and the conductive layers due to thermal shrinking. Moreover, the conductive layers may separate from the insulating layers with increasing ambient temperatures due to the difference in linear expansion coefficient between the insulating layers and the conductive layers.

### SUMMARY

An advantage of the invention is to increase the adhesiveness of a conductive layer formed by printing techniques to an underlying layer.

A first aspect of the invention provides a method for making layers, including (A) applying or supplying a liquid intermediate material on a first layer composed of a first insulating resin to form an intermediate material layer on the first layer; (B) applying or supplying a liquid conductive material containing a first metal on the intermediate material layer to form a conductive material layer on the intermediate material layer; and (C) activating the intermediate material layer and the conductive material layer to form an intermediate layer and a conductive layer on the intermediate layer. Here, the liquid intermediate material contains a precursor of a second insulating resin and fine particles of a second metal.

According to this method, a conductive layer that does not easily separate from an insulating resin layer can be formed by printing.

Preferably, the first insulating resin and the second insulating resin are the same. In this manner, the linear expansion coefficient of the insulating resin layer can be made equal to or close to the linear expansion coefficient of the intermediate layer.

Preferably, the first metal and the second metal are the same. In this manner, the linear expansion coefficient of the intermediate layer can be made equal to or close to the linear expansion coefficient of the conductive layer.

A second aspect of the invention provides a method for making layers, including (A) applying or supplying a liquid intermediate material on a first layer composed of an inorganic insulator to form an intermediate material layer on the first layer; (B) applying or supplying a liquid conductive material containing a first metal on the intermediate material layer to form a conductive material layer on the intermediate material layer; and (C) activating the intermediate material layer and the conductive material layer to form an intermediate layer and a conductive layer on the intermediate layer. Here, the liquid intermediate material contains a second inorganic insulator and fine particles of a second metal.

According to this method, a conductive layer not readily separable from a layer composed of an inorganic insulator can be formed by printing.

Preferably, the first inorganic insulator and the second inorganic insulator are the same. In this manner, the linear expansion coefficient of the layer composed of the inorganic insulator can be made equal or close to the linear expansion coefficient of the intermediate layer.

Preferably, the first metal and the second metal are the same. In this manner, the linear expansion coefficient of the intermediate layer can be made equal or close to the linear expansion coefficient of the conductive layer.

A third aspect of the invention provides a method for making layers, including (A) applying or supplying a liquid intermediate material on a first layer composed of a first insulating resin to form an intermediate material layer on the first layer; (B) applying or supplying a liquid conductive material containing a metal on the intermediate material layer to form a conductive material layer on the intermediate material layer; and (C) activating the intermediate material layer and the conductive material layer to form an intermediate layer and a conductive layer on the intermediate layer. Here, the liquid intermediate material contains a precursor of a second insulating resin, and fine particles of an inorganic material or a resin.

According to this method, the intermediate layer can be tightly bonded to the conductive layer by anchoring effects. This is because the liquid intermediate material contains fine particles of an inorganic material or a resin and the surface of the intermediate layer thus has irregularities corresponding to the average particle diameter of the fine particles of the inorganic material or the resin.

Preferably, the first insulating resin and the second insulating resin are the same. In this manner, the linear expansion coefficient of the insulting resin layer can be made equal to or close to the linear expansion coefficient of the intermediate layer.

A fourth aspect of the invention provides a method for making layers, including (A) applying or supplying a liquid intermediate material on a first layer composed of a first inorganic insulator to form an intermediate material layer on the first layer; (B) applying or supplying a liquid conductive material containing a metal on the intermediate material layer to form a conductive material layer on the intermediate material layer; and (C) activating the intermediate material layer and the conductive material layer to form an intermediate layer and a conductive layer on the intermediate. Here, the liquid intermediate material contains a second inorganic insulator and fine particles of an inorganic material or a resin.

According to this method, the intermediate layer can be tightly bonded to the conductive layer by anchoring effects. This is because the intermediate material contains fine particles of the inorganic material or the resin, and the surface of the intermediate layer thus has irregularities corresponding to the average diameter of the fine particles of the organic material or the resin.

Preferably, the first inorganic insulator and the second inorganic insulator are the same. In this manner, the linear expansion coefficient of the layer composed of the inorganic insulator can be made equal or close to the linear expansion coefficient of the intermediate layer.

Preferably, the liquid conductive material contains fine particles of the metal, and the average diameter of the fine particles of the inorganic material or the resin contained in the liquid intermediate material is larger than the average diameter of the fine particles of the metal contained in the liquid conductive material. In this manner, a conductive layer not readily separable from an underlying layer can be made by a printing technique involving applying or supplying a liquid conductive material containing metal fine particles.

A fifth aspect of the invention provides a method for making layers, including (A) applying or supplying a liquid intermediate material on a first layer composed of a first insulating resin to form an intermediate material layer on the first layer; (B) applying or supplying a liquid conductive material containing fine particles of a metal on the intermediate material layer before the intermediate material layer is completely dried so as to form a conductive material layer on the intermediate material layer; and (C) activating the intermediate material layer and the conductive material layer to form an intermediate layer and a conductive layer on the intermediate layer. wherein the liquid intermediate material contains a precursor of a second insulating resin.

According to this method, a conductive layer not easily separable from a layer composed of an insulating resin can be formed by printing.

Preferably, the first insulating resin and the second insulating resin are the same. In this manner, the linear expansion coefficient of the layer composed of the insulating resin can be made equal or close to the linear expansion coefficient of the intermediate layer.

A sixth aspect of the invention provides a method for making layers, including (A) applying or supplying a liquid intermediate material on a first layer composed of a first inorganic insulator to form an intermediate material layer on the first layer; (B) applying or supplying a liquid conductive material containing fine particles of a metal on the intermediate material layer before the intermediate material layer is completely dried to form a conductive material layer on the intermediate material layer; and (C) activating the intermediate material layer and the conductive material layer to form an intermediate layer and a conductive layer on the intermediate layer. Here, the liquid intermediate material contains a second inorganic insulator.

According to this method, a conductive layer not easily separable from a layer composed of the inorganic insulator can be formed by printing.

Preferably, the first inorganic insulator and the second inorganic insulator are the same. In this manner, the linear expansion coefficient of the layer composed of an inorganic insulator can be made equal or close to the linear expansion coefficient of the intermediate layer.

A seventh aspect of the invention provides a wiring board made by any one of the above-described methods. In this manner, a wiring board having a conductive layer not easily separable from an underlying layer can be formed by printing.

### BRIEF DESCRIPTION OF THE DRAWINGS

The invention will be described with reference to the accompanying drawings, wherein like numbers reference like elements, and wherein:

FIG. 1 is a schematic diagram showing a layer-forming apparatus according to one of first to sixth embodiments;

FIG. 2 is a schematic diagram showing a discharger according to one of the first to sixth embodiments;

FIG. 3 is a schematic diagram showing a discharging head unit of the discharger;

FIGS. 4A and 4B are schematic diagrams showing a head of the discharger;

FIG. 5 is a diagram showing a controlling unit of the discharger;

FIGS. 6A to 6D show a production process according to the first embodiment;

FIGS. 7A to 7D show a production process according to the first embodiment;

FIGS. 8A to 8D show a production process according to the second embodiment;

FIGS. 9A to 9C show a production process according to the second embodiment;

FIGS. 10A to 10D show a production process according to the third embodiment;

FIGS. 11A to 11C show a production process according to the third embodiment;

FIGS. 12A to 12D show a production process according to the fourth embodiment;

FIGS. 13A to 13C show a production process according to the fourth embodiment;

FIGS. 14A to 14D show a production process according to the fifth embodiment;

FIGS. 15A to 15C show a production process according to the fifth embodiment;

FIGS. 16A to 16D show a production process according to the sixth embodiment;

FIGS. 17A to 17C show a production process according to the sixth embodiment;

FIG. 18 is a schematic diagram showing a cellular phone according to an embodiment; and

FIG. 19 is a schematic diagram showing a personal computer according to another embodiment.

### DESCRIPTION OF THE EMBODIMENTS

### First Embodiment

A wiring board of a first embodiment is made from a tape-shaped base substrate 1a. The base substrate 1a is composed of polyimide and is also referred to as a “flexible substrate”. A conductive wiring is formed on the base substrate 1a by the process described below. After formation of the conductive wiring, the base substrate 1a is subjected to press treatment and a plurality of substrates is cut out from the base substrate 1a. In other words, a plurality of substrates each having a conductive wiring is obtained from the base substrate 1a. In this embodiment, the conductive wirings formed on the substrates have the same pattern. The substrate on which the conductive wiring is formed is referred to as “wiring board”.

(A. Layer-Forming Apparatus)

The wiring board of this embodiment is made using three apparatuses. These three apparatuses for making layers have the same basic structure and functions. For purposes of simplification, the structure and functions of only one of these apparatuses will be described below.

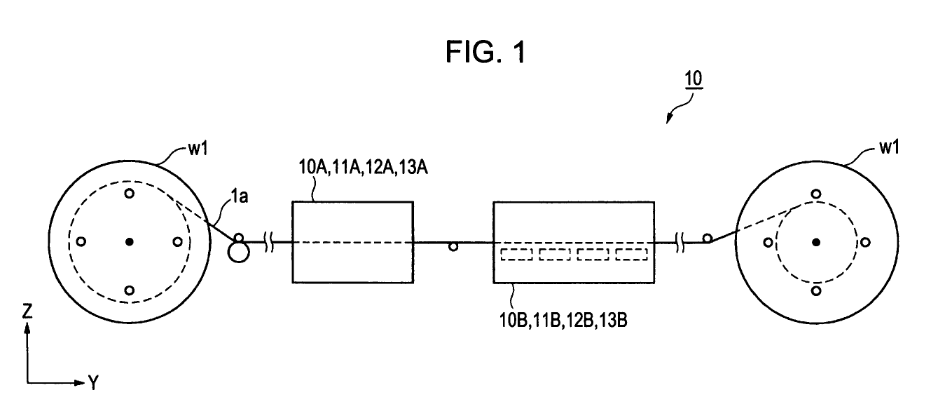

A layer-forming apparatus 10 shown in FIG. 1 forms a conductive layer or an insulating layer on a surface located at a particular level. The layer-forming apparatus 10 includes a pair of reels W1, a discharger 10A, and an oven 10B. While the base substrate 1a is being unwound from one of the reels W1 and taken up by the other one of the reels W1, the base substrate 1a is processed in the discharger 10A and the oven 10B. Such a technique is called a “reel to reel” process.

The discharger 10A discharges a liquid material toward a surface of the base substrate 1a located at a predetermined level. The oven 10B heats, i.e., activates, the liquid material supplied or applied onto the base substrate 1a using the discharger 10A. For explanation purposes, the three dischargers of the three layer-forming apparatuses 10 are referred to as a discharger 11A, a discharger 12A, and a discharger 13A, respectively, in this specification. Similarly, the three ovens are referred to as an oven 11B, an oven 12B, and an oven 13B, respectively, in this specification.

The three dischargers 11A, 12A, and 13A have the same basic structure and functions. Thus, the structure and functions of only the discharger 11A is explained below to avoid redundancy.

(B. Overall Structure of the Discharger)

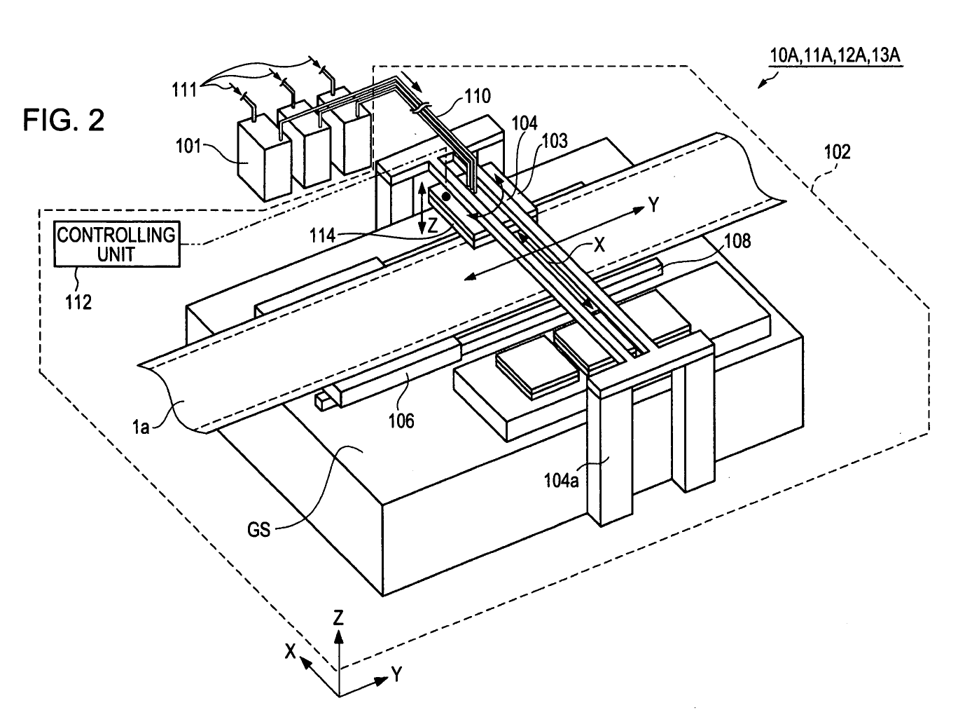

FIG. 2 shows the discharger 11A that functions as an inkjet device. In detail, the discharger 11A includes tanks 101 containing a liquid material 111, tubes 110, and a scanning discharger unit 102 to which the liquid material 111 is fed from the tanks 101 via the tubes 110. The scanning discharger unit 102 includes a grandstage GS, a discharging head unit 103, a stage 106, a first position controller 104, a second position controller 108, a controlling unit 112, and a support 104a.

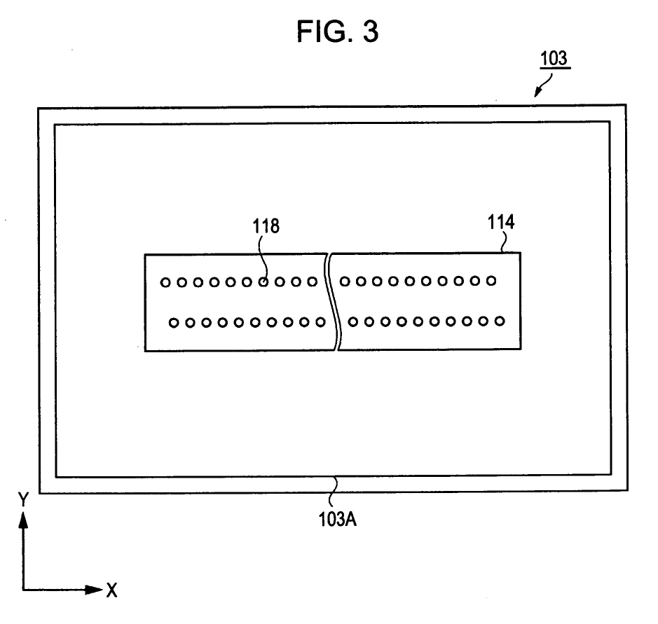

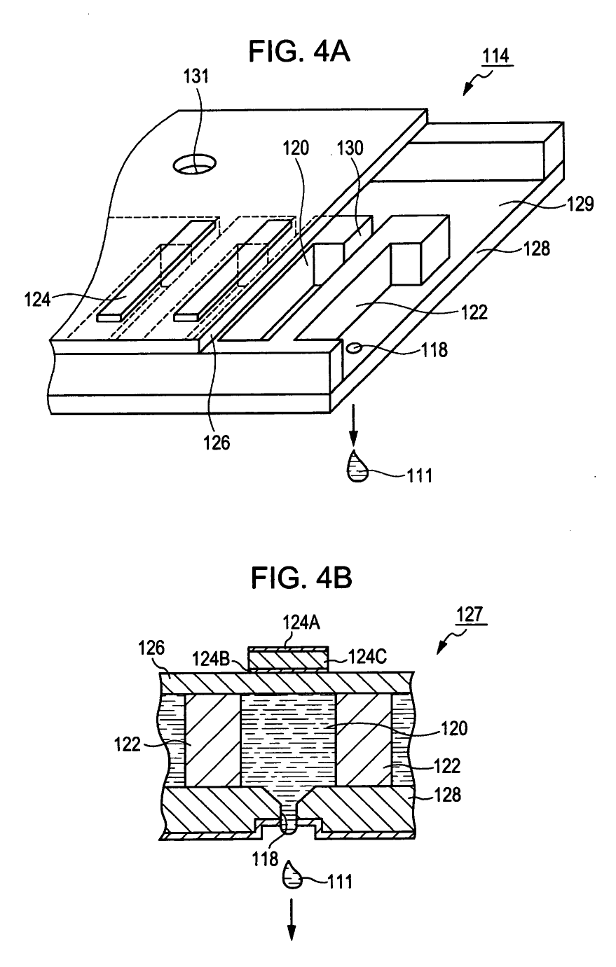

The discharging head unit 103 has a head 114 (shown in FIGS. 3, 4A, and 4B). The head 114 discharges droplets of the liquid material 111 in response to the signal sent from the controlling unit 112. The head 114 of the discharging head unit 103 is connected to the tanks 101 via the tubes 110. The liquid material 111 is thus fed to the head 114 from the tank 101.

The stage 106 has a flat surface for affixing the base substrate 1a. The stage 106 fixes the base substrate 1a by suction.

The first position controller 104 is fixed at a predetermined height from the grandstage GS by using the support 104a. The first position controller 104 moves the discharging head unit 103 in the X axis direction and the Z axis direction orthogonal to the X axis direction in response to the signal sent from the controlling unit 112. The first position controller 104 also rotates the discharging head unit 103 about a shaft parallel to the Z axis. In this embodiment the Z axis direction is parallel to the vertical direction, i.e., the direction in which the acceleration of gravity works.

The second position controller 108 moves the stage 106 in the Y axis direction on the grandstage GS in response to the signal sent from the controlling unit 112. The Y axis direction is orthogonal to both the X axis and the Z axis.

The above-described functions of the first position controller 104 and the second position controller 108 are realized by known XY robots that use linear motors and servomotors. Thus, the detailed structures of these controllers are not described here. Note that in this specification, the first position controller 104 and the second position controller 108 are also referred to as “robot” or “scanning unit”.

As is described above, the first position controller 104 moves the discharging head unit 103 in the X axis direction. The second position controller 108 moves the base substrate 1a and the stage 106 in the Y axis direction. As a result, the position of the base substrate 1a relative to the head 114 changes. In particular, by these movements, the discharging head unit 103, the head 114, or nozzles 118 (refer to FIGS. 3, 4A, and 4B) moves, i.e., scans, in the X and Y axis directions relative to the base substrate 1a while maintaining the distance to the base substrate 1a in the Z axis direction. Here, “move relative to” or “scan relative to” means that at least one of the unit that discharges the liquid material 111 and the work onto which the discharged liquid material lands is moved relative to the other.

The controlling unit 112 receives discharge data, e.g., bitmap data, indicating the relative positions of discharging the liquid material 111 from an external data processor. The controlling unit 112 stores the received discharge data in an internal storage and controls the first position controller 104, the second position controller 108, and the head 114 based on the stored discharge data.

The discharger 11A moves the nozzles 118 (see FIGS. 3, 4A, and 4B) of the head 114 relative to the base substrate 1a based on the bitmap data (discharge data) while discharges the liquid material 111 from the nozzles 118 toward target regions. The bitmap data is provided to supply the material on the base substrate 1a so that a predetermined pattern is formed. A series of the scanning motion of the head 114 controlled by the discharger 11A and discharging of the liquid material 111 from the head 114 is generally referred to as “application scanning” or “discharge scanning”.

The “target region” is where the droplets of the liquid material 111 are designed to land. The target region may be formed by surface-modifying a base material so that the liquid material 111 forms a desired angle of contact. When the surface of the base material itself has desired repellent or lyophilic property to the liquid material 111 without surface modification, i.e., when the liquid material 111 can form a desired angle of contact on the surface of the base material without any treatment, that surface of the base material may be used as the target region. In this specification, the “target region” is also referred to as “target” or “receiving region”.

(C. Head)

As shown in FIG. 3, the head 114 is fixed by a carriage 103A of the discharging head unit 103. The head 114 is an inkjet head having a plurality of nozzles 118. In detail, as shown in FIGS. 4A and 4B, the head 114 has a diaphragm 126 and a nozzle plate 128 that defines the apertures of the nozzles 118. A liquid reservoir 129 lies between the diaphragm 126 and the nozzle plate 128. The liquid reservoir 129 is filled with the liquid material 111 supplied from an external tank (not shown in the drawing) via a hole 131.

Between the diaphragm 126 and the nozzle plate 128, barriers 122 are disposed. A portion defined by the diaphragm 126, the nozzle plate 128, and a pair of barriers 122 is a cavity 120. One cavity 120 is provided per nozzle 118. Thus, the number of the cavities 120 is the same as the number of the nozzles 118. The liquid material 111 is fed to the cavity 120 from the liquid reservoir 129 via a supply port 130 positioned between the pair of barriers 122. In this embodiment, the diameter of the nozzle 118 is about 27 μm.

On the diaphragm 126, one oscillator 124 is disposed per cavity 120. Each oscillator 124 includes a piezoelectric element 124C and a pair of electrodes 124A and 124B sandwiching the piezoelectric element 124C, as shown in FIG. 4B. The controlling unit 112 applies a driving voltage between the electrodes 124A and 124B to discharge droplets D of the liquid material 111 from the corresponding nozzle 118. The volume of the material discharged from the nozzle 118 is variable in the range of 0 to 42 pl. The shape of the nozzle 118 is adjusted so that the droplets D of the liquid material 111 are discharged in the Z direction from the nozzle 118.

In this specification, the nozzle 118, the cavity 120 corresponding to this nozzle 118, and the oscillator 124 corresponding to that cavity 120 are sometimes referred together as “discharge unit 127”. One head 114 has as many discharge units 127 as the nozzles 118. The discharge unit 127 may include an electrothermal conversion element instead of piezoelectric element. In other words, the discharge unit 127 may discharge the material by utilizing the thermal expansion of the material using the electrothermal conversion element.

(D. Controlling Unit)

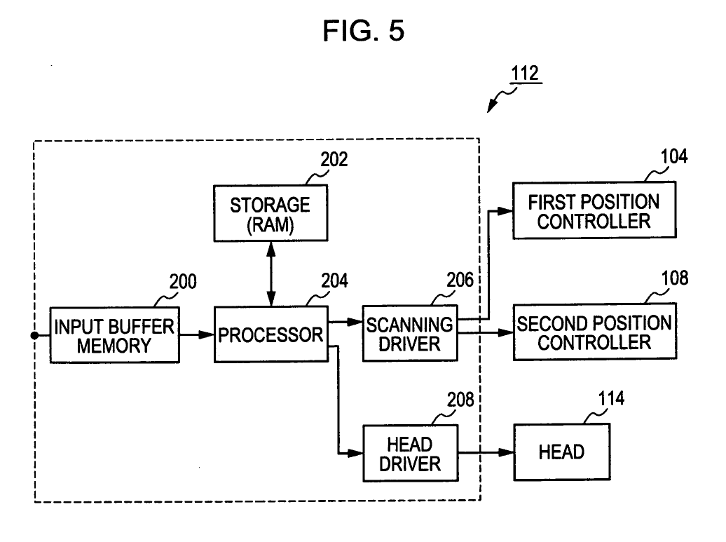

The structure of the controlling unit 112 will now be described. As shown in FIG. 5, the controlling unit 112 includes an input buffer memory 200, a storage 202, a processor 204, a scanning driver 206, and a head driver 208. The input buffer memory 200 is connected to and communicates with the processor 204. The processor 204, the storage 202, the scanning driver 206, and the head driver 208 are connected to one another via a bus (not shown) and can communicate with one another.

The scanning driver 206 is connected to and can communicate with the first position controller 104 and the second position controller 108. The head driver 208 is connected to and can communicate with the head 114.

The input buffer memory 200 receives discharge data for discharging droplets of the liquid material 111 from an external data processor (not shown) outside the discharger 10A. The input buffer memory 200 supplies the discharge data to the processor 204, and the processor 204 stores the discharge data in the storage 202. In the system shown in FIG. 5, the storage 202 is a RAM.

Based on the discharge data stored in the storage 202, the processor 204 supplies the scanning driver 206 with the data indicating the positions of the nozzles 118 relative to the target regions. The scanning driver 206 supplies the second position controller 108 with a stage driving signal based on this data and the cycle of discharge. As a result, the position of the discharging head unit 103 relative to the target regions changes. Meanwhile, the processor 204 provides the head 114 with a discharge signal necessary for discharging the liquid material 111 based on the discharge data stored in the storage 202. The droplets of the liquid material 111 are discharged from the designated nozzles 118 of the head 114 as a result.

The controlling unit 112 may be a computer including a CPU, a ROM, a RAM, and a bus. In such a controlling unit 112, the functions of the controlling unit 112 described above are realized by a software program run on the computer. Alternatively, the controlling unit 112 may be a circuit (hardware) dedicated for this purpose.

(E. Liquid Material)

The liquid material 111 is any material having a viscosity that can form droplets from the nozzles 118 of the head 114. The liquid material 111 may be aqueous or oil-based. The liquid material 111 needs to have a flowability (viscosity) sufficient to be discharged from the nozzles 118 and may contain a solid substance as long as the liquid material 111 is fluid as a whole. The viscosity of the liquid material 111 is in the range of 1 mPa·s to 50 mPa·s. When the viscosity is 1 mPa·s or more and the droplets of the liquid material 111 are discharged from the nozzles 118, the periphery of the nozzles 118 is rarely contaminated with the liquid material 111. At a viscosity of 50 mPa·s or less, clogging of the nozzles 118 is less frequent, and droplets can be discharged smoothly.

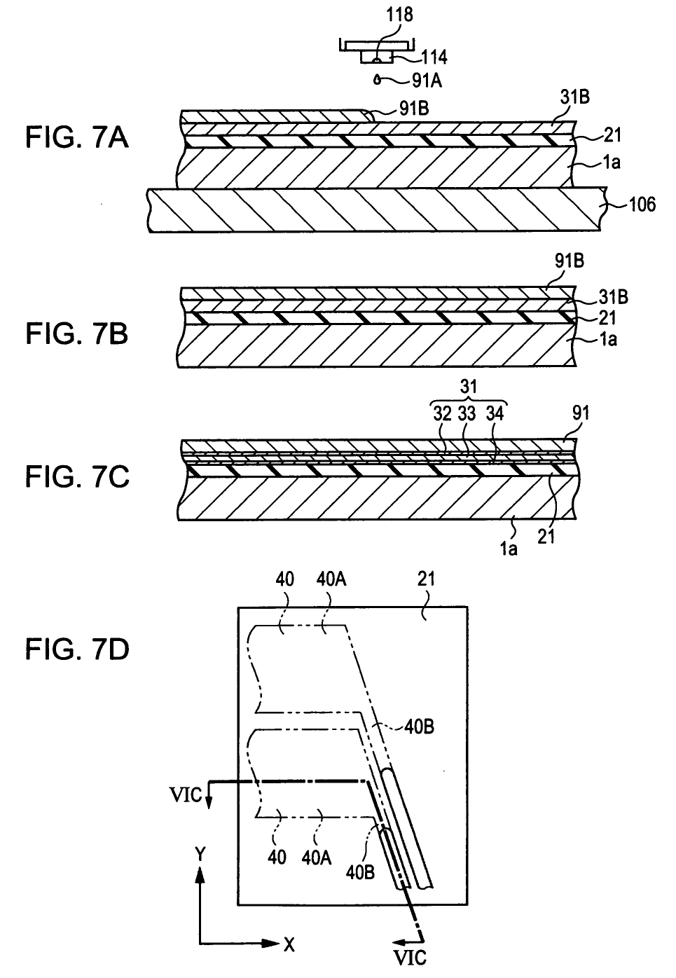

A conductive material 91A (see FIG. 7A) described below is one type of the liquid material described above. The conductive material 91A in this embodiment contains silver particles having an average diameter of about 10 nm, a dispersant, and an organic solvent, such as toluene or xylene. The silver particles in the conductive material are coated with the dispersant so that the silver particles can be stably dispersed in the organic solvent. The dispersant here is a compound that can coordinate with silver atoms.

Examples of the dispersant include amines, alcohols, and thiols. Specific examples of the dispersant include amines such as 2-methylaminoethanol, diethanolamine, diethylmethylamine, 2-dimethylaminoethanol, and methyldiethanolamine; alkylamines; ethylene diamine; alkyl alcohols; ethylene glycol; propylene glycol; alkylthiols; and ethanedithiol.

Particles having an average diameter of about one to several hundred nanometers are also referred to as “nanoparticles”. According to this definition, the conductive material of this embodiment contains silver nanoparticles.

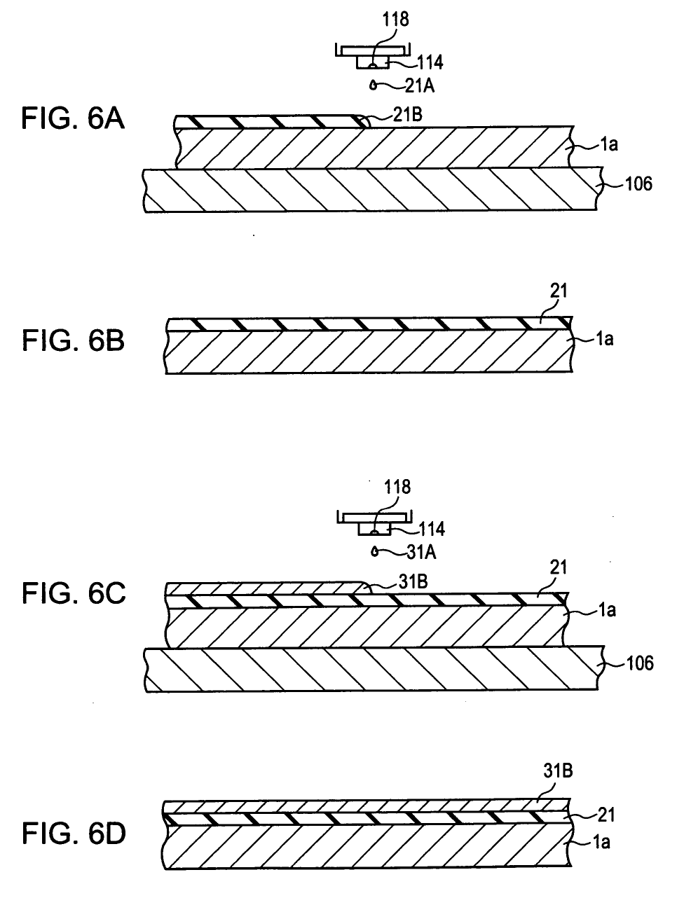

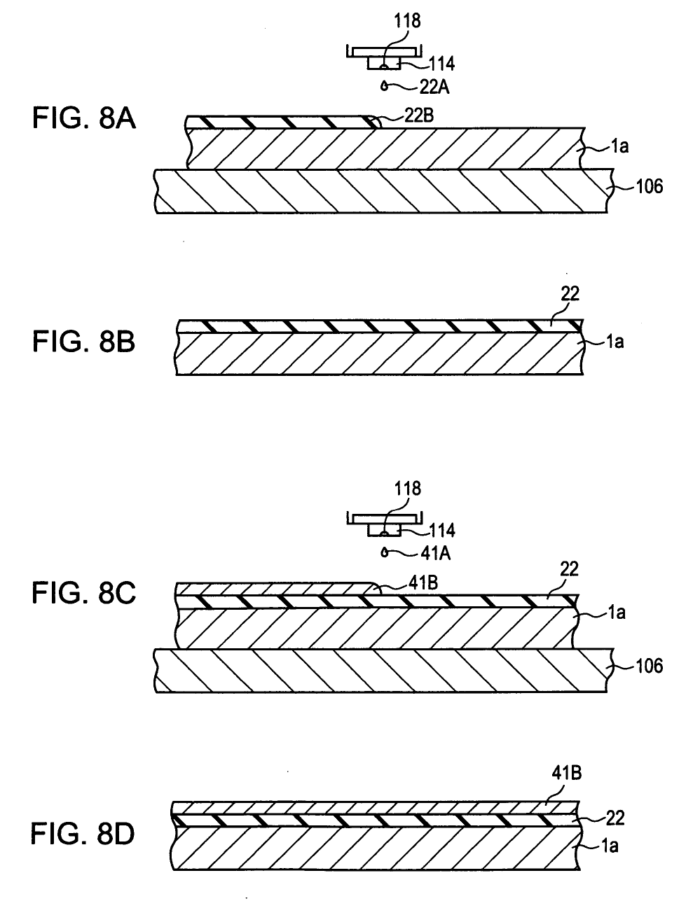

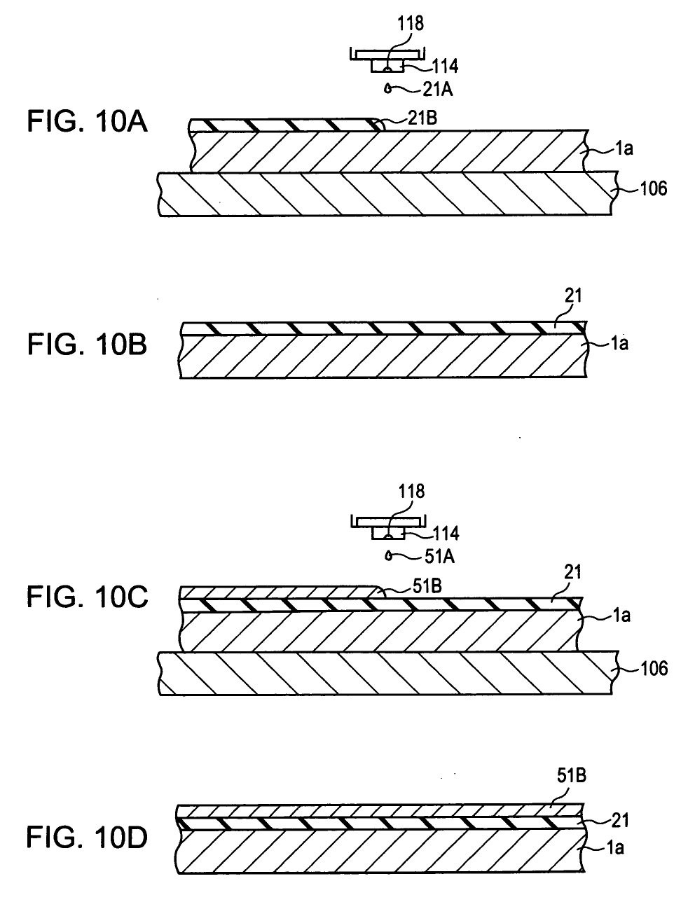

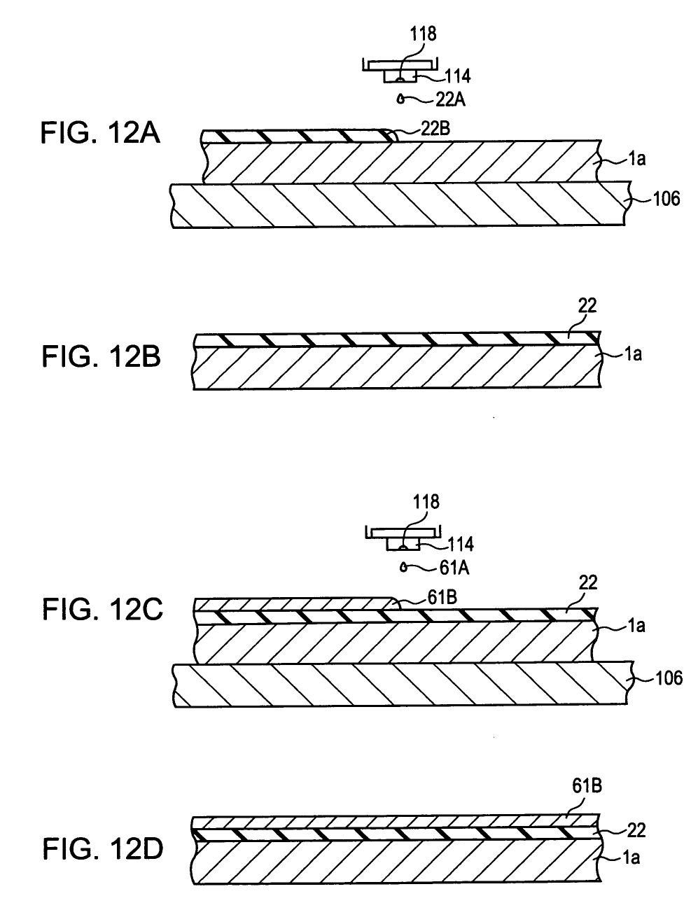

An insulating material 21A (see FIGS. 6A and 10A) and an insulating material 22A (see FIGS. 8A and 12A) described below are also examples of the liquid material. The insulating material 21A contains a polyimide precursor and N-methyl-2-pyrrolidone as a solvent (diluent). The insulating material 22A contains nanoparticles of silica (silicon dioxide), which is an inorganic insulator, and a solvent. The average diameter of the silica nanoparticles contained in the insulating material 22A is about 10 nm. The solvent (diluent) in the insulating material 22A is water.

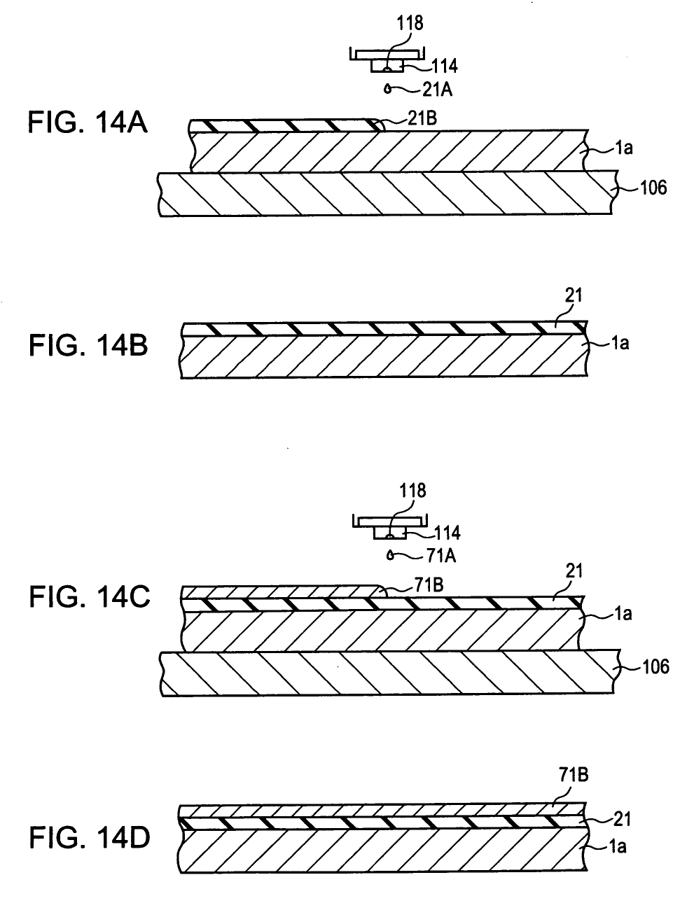

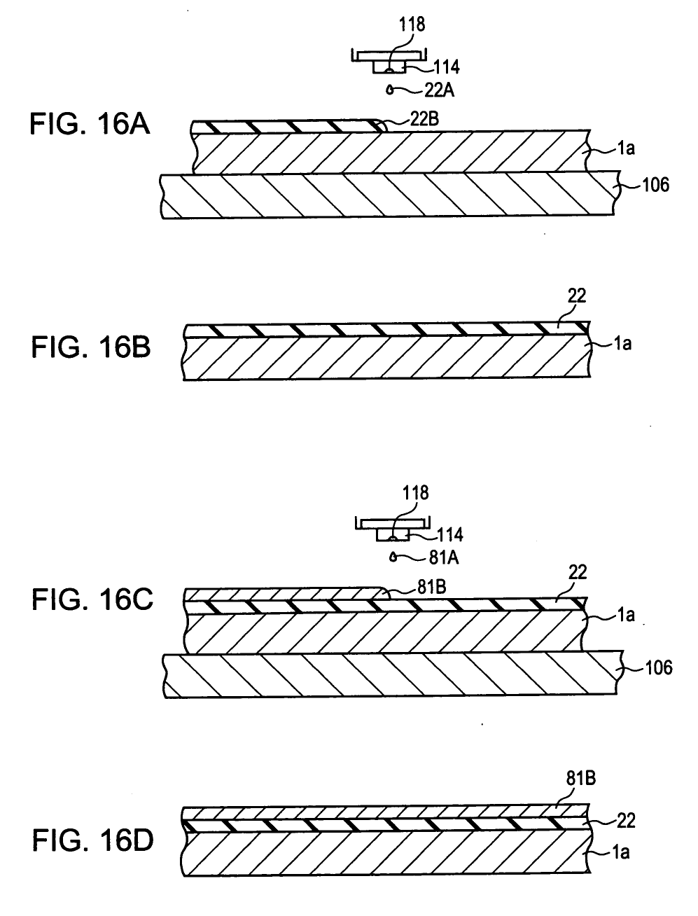

Intermediate materials 31A (FIG. 6C), 41A (FIG. 8C), 51A (FIG. 10C), 61A (FIG. 12C), 71A (FIG. 14C), and 81A (FIG. 16C) described below are also examples of the liquid material.

The intermediate material 31A is a liquid material containing a polyimide precursor, N-methyl-2-pyrroliodone, which is a solvent, silver nanoparticles, and a dispersant for dispersing the silver nanoparticles. The intermediate material 41A is a liquid material containing silica nanoparticles having an average diameter of about 10 nm, a solvent (diluent), silver nanoparticles, and a dispersant for dispersing the silver nanoparticles.

The intermediate material 51A is a liquid material containing a polyimide precursor, N-methyl-2-pyrroliodone, which is a solvent, and silica nanoparticles having an average diameter of about 50 nm. The intermediate material 61A is a liquid material containing silica nanoparticles having an average diameter of about 10 nm, a solvent (diluent), and silica nanoparticles having an average diameter of 50 nm.

The intermediate material 71A is a liquid material containing a polyimide precursor and N-methyl-2-pyrrolidone as a solvent. In this embodiment the intermediate material 71A is the same as the insulating material 21A. The intermediate material 81A is a liquid material containing silica nanoparticles having an average diameter of about 10 nm and a solvent (diluent). In this embodiment, the intermediate material 81A is the same as the insulating material 22A.

Next, a method for making layers will be described. The method of this embodiment is part of the process for making a wiring board.

(F1. Insulating Layers)

First, the oxide film 21 is formed on the base substrate 1a. In detail, as shown in FIG. 6A, the base substrate 1a is placed on the stage 106 of the discharger 11A. The discharger 11A forms an insulating material layer 21B on the base substrate 1a based on first bitmap data. Here, the insulating material layer 21B substantially completely covers one of the surfaces of the base substrate 1a. In other words, the insulating material layer 21B is a fully overlaying layer.

In detail, the discharger 11A first adjusts the positions of the nozzles 118 relative to the base substrate 1a of the discharger 11A in the X axis direction and the Y axis direction. After the nozzles 118 reached the positions corresponding to the target regions on the base substrate 1a, the discharger 11A discharges droplets of the insulating material 21A from the nozzles 118. Here, the insulating material 21A is a liquid material containing a polyimide precursor and a solvent. The discharged droplets of the insulating material 21A land on the target regions of the base substrate 1a and form the insulating material layer 21B on the target regions of the base substrate 1a.

The insulating material layer 21B is then activated. In order to activate the insulating material layer 21B, the base substrate 1a is placed in the oven 11B in this embodiment. The insulating material layer 21B is heated so that the polyimide precursor in the insulating material layer 21B is cured to form a polyimide layer. As a result of the activation, an insulating layer 21 (polyimide layer) is formed on the base substrate 1a, as shown in FIG. 6B.

(F2. Intermediate Layer and Conductive Layer)

After the formation of the insulating layer 21, an intermediate layer 31 and a conductive layer 91 both having the same pattern are formed. Here, the conductive layer 91 is stacked on the intermediate layer 31.

In particular, as shown in FIG. 6C, the base substrate 1a having the insulating layer 21 is placed on the stage 106 of the discharger 12A. The discharger 12A forms an intermediate material layer 31B on the insulating layer 21 based on second bitmap data. Note that FIG. 6C is a cross-sectional view of these layers taken along line VIC-VIC in FIG. 7D.

In detail, the discharger 12A adjusts the positions of the nozzles 118 relative to the base substrate 1a in the X axis and Y axis directions. After the nozzles 118 reached the positions corresponding to a conductive pattern 40, the discharger 12A discharges droplets of the intermediate material 31A from the nozzles 118. Here, the intermediate material 31A is a liquid material containing a polyimide precursor, a solvent, and silver particles having an average diameter of about 10 nm. The discharged droplets of the intermediate material 31A land on the target regions of the insulating layer 21, thereby forming the intermediate material layer 31B on the target regions of the insulating layer 21, as shown in FIG. 6D.

The conductive pattern 40 is a pattern in which conductive wiring is to be formed, as shown in FIG. 7D. The conductive wiring is formed with the conductive layer 91 (FIG. 7C) of this embodiment. As shown in FIG. 7D, the conductive pattern 40 includes electrode segments 40A and wiring segments 40B connected to each other. The electrode segments 40A provide electrical and physical connections to electrode pads or the like of other semiconductor devices.

After the intermediate material layer 31B is formed, a conductive material layer 91B having the shape of the conductive pattern 40 is formed. In order to do so, the base substrate 1a is taken up on the reel W1 together with a spacer for protecting the intermediate material layer 31B. Subsequently, the reel W1 carrying the base substrate 1a is mounted to a layer-forming apparatus including the discharger 13A. In this embodiment the oven 12B is not used, and the intermediate material layer 31B is not completely cured. Alternatively, the intermediate material layer 31B may be irradiated with UV light, such as i line, immediately after the formation.

In detail, as shown in FIG. 7A, the base substrate 1a with the intermediate material layer 31B is placed on the stage 106 of the discharger 13A. The discharger 13A forms the conductive material layer 91B on the intermediate material layer 31B based on third bitmap data.

To be more specific, the discharger 13A adjusts the positions of the nozzles 118 relative to the base substrate 1a in the X axis and the Y axis directions. After the nozzles 118 reached the positions corresponding to the conductive pattern 40, the discharger 13A discharges droplets of the conductive material 91A from the nozzles 118. The droplets of the conductive material 91A land on the intermediate material layer 31B and form the conductive material layer 91B on the intermediate material layer 31B, as shown in FIG. 7B.

After the formation of the conductive material layer 91B, the intermediate material layer 31B and the conductive material layer 91B are activated. In this embodiment, the base substrate 1a is placed in the oven 13B, and the intermediate material layer 31B and the conductive material layer 91B are heated to form the intermediate layer 31 and the conductive layer 91 tightly bonded to each other, as shown in FIG. 7C. The intermediate layer 31 is constituted from a first connection sublayer 32, a buffer sublayer 33, and a second connection sublayer 34, as described below.

When the intermediate material layer 31B and the conductive material layer 91B are activated, the polyimide precursor in the intermediate material layer 31B is cured to form the buffer sublayer 33 in the intermediate material layer 31B. Moreover, the silver particles in the conductive material 91A are sintered or melt-bonded to each other to form the conductive layer 91 in the conductive material layer 91B. Meanwhile, the silver particles in the surface of the intermediate material layer 31B are sintered or melt-bonded to silver particles in the surface of the conductive material layer 91B to form the first connection sublayer 32 between the buffer sublayer 33 and the conductive layer 91. Consequently, the buffer sublayer 33 is bonded to the conductive layer 91 via the first connection sublayer 32.

As a result of the activation, the polyimide in the surface of the insulating layer 21 combines with the polyimide precursor in the other surface of the intermediate material layer 31B, thereby forming the second connection sublayer 34 between the insulating layer 21 and the buffer sublayer 33. Thus, the insulating layer 21 is bonded to the buffer sublayer 33 via the second connection sublayer 34. The polyimide in the insulating layer 21 and the polyimide in the intermediate layer 31 formed by the activation correspond to the “insulating resin” of the invention.

Accordingly, the intermediate layer 31 tightly bonds to both the insulating layer 21 and the conductive layer 91. The intermediate layer 31 contains polyimide and silver, i.e., the same insulating resin contained in the insulating layer 21 and the same metal contained in the conductive layer 91. Thus, the linear expansion coefficient of the intermediate layer 31 comes between the linear expansion coefficient of the insulating layer 21 and the linear expansion coefficient of the conductive layer 91. Thus, compared to a structure that has no intermediate layer 31, the stress generated when the insulating layer 21 undergoes thermal expansion is small. Thus, separation of the conductive layer 91 due to thermal expansion is less frequent compared to the structure that has no intermediate layer 31.

As is described above, the intermediate material 31A of this embodiment contains a precursor of the insulating resin, and the insulating resin generated by activating the precursor is the same as the insulating resin constituting the underlying insulating layer 21. Note that the insulating resin in the intermediate layer 31 may be different from the insulating resin in the insulating layer 21 if the linear expansion coefficient of the insulating resin in the insulating layer 21 is substantially equal to or close to the linear expansion coefficient of the insulating resin in the intermediate layer 31. Similarly, if the linear expansion coefficient of the metal in the intermediate layer 31 is substantially equal or close to that of the metal in the conductive layer 91, the metal in the intermediate layer 31 may be different from the metal in the conductive layer 91.

### Second Embodiment

Next, a method of making layers according to a second embodiment will be described. The method of this embodiment is basically the same as the method of the first embodiment except that the insulating material 22A and the intermediate material 41A are used instead of the insulating material 21A and the intermediate material 31A, respectively.

(G1. Insulating Layer)

First, the first insulating film 22 composed of an inorganic insulator is formed on the base substrate 1a. In particular, as shown in FIG. 8A, the base substrate 1a is placed on the stage 106 of the discharger 11A. The discharger 11A forms an insulating material layer 22B on the base substrate 1a based on first bitmap data. Here, the insulating material layer 22B substantially completely covers one of the surfaces of the base substrate 1a. In other words, the insulating material layer 22B is a fully overlaying layer.

In detail, the discharger 11A adjusts the positions of the nozzles 118 relative to the base substrate 1a in the X axis and Y axis directions. After the nozzles 118 reached the positions corresponding to the target regions of the base substrate 1a, the discharger 11A discharges droplets of the insulating material 22A from the nozzles 118. Here, the insulating material 22A is a liquid material containing an inorganic insulator and a solvent. The discharged droplets of the insulating material 22A land on the target regions of the base substrate 1a to form an insulating material layer 22B on the target regions of the base substrate 1a.

After the formation of the insulating material layer 22B, the insulating material layer 22B is activated. In this embodiment, the base substrate 1a is placed in the oven 11B, and the insulating material layer 22B is heated to precipitate or melt-bond the inorganic insulator in the insulating material layer 22B. As a result of the activation, an insulating layer 22 is formed on the base substrate 1a, as shown in FIG. 8B.

(G2. Intermediate Layer and Conductive Layer)

After the formation of the insulating layer 22, an intermediate layer 41 and the conductive layer 91 having the shape of the conductive pattern 40 (shown in FIG. 7D) are formed. Here, the conductive layer 91 is stacked on the intermediate layer 41.

In particular, the base substrate 1a having the insulating layer 22 is placed on the stage 106 of the discharger 12A, as shown in FIG. 8C. The discharger 12A forms an intermediate material layer 41B on the insulating layer 22 based on second bitmap data.

In detail, the discharger 12A adjusts the positions of the nozzles 118 relative to the base substrate 1a in the X and Y axis directions. After the nozzles 118 reached the positions corresponding to the conductive pattern 40, the discharger 12A discharges droplets of the intermediate material 41A from the nozzles 118. Here, the intermediate material 41A contains an inorganic insulator, a solvent, and silver particles having an average diameter of about 10 nm. The discharged droplets of the intermediate material 41A land on the target regions of the insulating layer 22 to form the intermediate material layer 41B on the target regions of the insulating layer 22, as shown in FIG. 8D.

After the formation of the intermediate material layer 41B, the conductive material layer 91B having the shape of the conductive pattern 40 is formed. In order to do so, the base substrate 1a is taken up on the reel W1 with a spacer for protecting the intermediate material layer 41B. Subsequently, the reel W1 carrying the base substrate 1a is mounted to a layer-forming apparatus including the discharger 13A. In this embodiment, the oven 12B is not used. Thus, the intermediate material layer 41B is not completely cured.

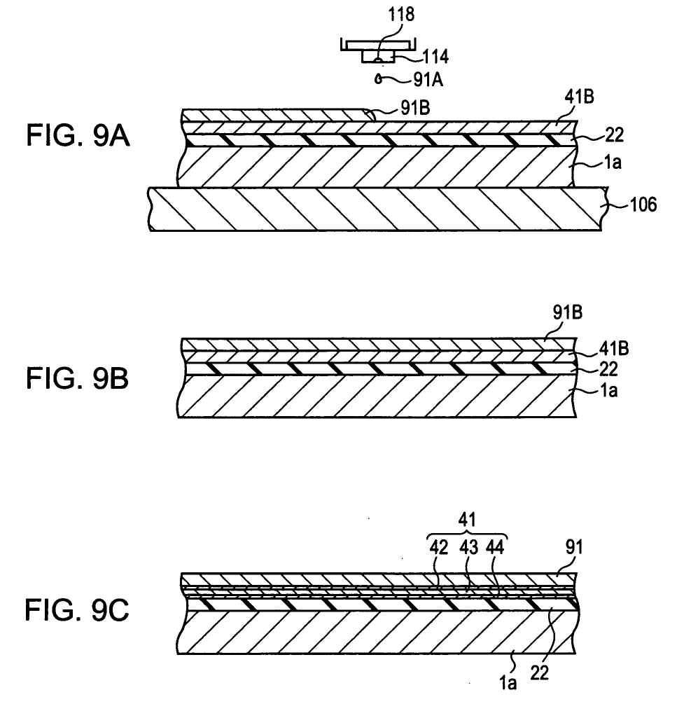

In detail, as shown in FIG. 9A, the base substrate 1a with the intermediate material layer 41B is placed on the stage 106 of the discharger 13A. The discharger 13A forms the conductive material layer 91B on the intermediate material layer 41B base on third bitmap data.

To be more specific, the discharger 13A adjusts the positions of the nozzles 118 relative to the base substrate 1a in the X axis and Y axis directions. After the nozzles 118 reached the positions corresponding to the conductive pattern 40, droplets of the conductive material 91A are discharged from the nozzles 118. The discharged droplets of the conductive material 91A land on the intermediate material layer 41B and form the conductive material layer 91B on the intermediate material layer 41B, as shown in FIG. 9B.

After the formation of the conductive material layer 91B, the intermediate material layer 41B and the conductive material layer 91B are activated. In this embodiment, the base substrate 1a is placed in the oven 13B. The intermediate material layer 41B and the conductive material layer 91B are then heated to obtain the intermediate layer 41 and the conductive layer 91 tightly bonded to each other, as shown in FIG. 9C. The intermediate layer 41 includes a connection layer a first connection sublayer 42, a buffer sublayer 43, and a second connection sublayer 44, as described below.

When the intermediate material layer 41B and the conductive material layer 91B are activated, the inorganic insulator in the intermediate material layer 41B is precipitated or melt-bonded to form the buffer sublayer 43 in the intermediate material layer 41B. The silver particles in the conductive material 91A is sintered or melt-bonded to form the conductive layer 91 in the conductive material layer 91B. Meanwhile, the silver particles in the surface of the intermediate material layer 41B are sintered or melt-bonded to the silver particles in the surface of the conductive material layer 91B to form the first connection sublayer 42 between the buffer sublayer 43 and the conductive layer 91. As a result, the buffer sublayer 43 tightly bonds to the conductive layer 91 via the first connection sublayer 42.

As a result of the activation, the inorganic insulator in the surface of the insulating layer 22 combines with the inorganic insulator in the other surface of the intermediate material layer 41B, thereby forming the second connection sublayer 44 between the insulating layer 22 and the buffer sublayer 43. Thus, the insulating layer 22 is tightly bonded to the buffer sublayer 43 with the second connection sublayer 44 therebetween.

Accordingly, the intermediate layer 41 also tightly bonds to the insulating layer 22 and the conductive layer 91. The intermediate layer 41 contains an inorganic insulator and silver. In other words, the intermediate layer 41 contains the same inorganic insulator as the insulating layer 22 and the same metal as the conductive layer 91. Thus, the linear expansion coefficient of the intermediate layer 41 comes between the linear expansion coefficient of the insulating layer 22 and the linear expansion coefficient of the conductive layer 91. Compared to a structure that has no intermediate layer 41, the stress generated when the insulating layer 22 undergoes thermal expansion is small. Thus, separation of the conductive layer 91 due to thermal expansion is less frequent compared to the structure that has no intermediate layer 41.

As is described above, the intermediate material 41A of this embodiment contains the same inorganic insulator as that constituting the insulating layer 22. Note that the inorganic insulator in the insulating layer 22 may be different from the inorganic insulator in the intermediate layer 41 if the linear expansion coefficient of the inorganic insulator in the insulating layer 22 is equal or close to the linear expansion coefficient of the intermediate layer 41. Similarly, if the linear expansion coefficient of the metal in the intermediate layer 41 is substantially equal or close to that of the metal in the conductive layer 91, the metal in the intermediate layer 41 may be different from the metal in the conductive layer 91.

### Third Embodiment

A method for making layers according to a third embodiment will now be described. The method of this embodiment is basically the same as the method of the first embodiment except that the intermediate material 51A is used instead of the intermediate material 31A.

(H1. Insulating Layer)

First, the insulating layer 21 composed of an insulating resin is formed on the base substrate 1a. In particular, as shown in FIG. 10A, the base substrate 1a is placed on the stage 106 of the discharger 11A. The discharger 11A forms the insulating material layer 21B on the base substrate 1a based on first bitmap data. Here, the insulating material layer 21B substantially completely covers one of the surfaces of the base substrate 1a. In other words, the insulating material layer 21B is a fully overlaying layer.

In detail, the discharger 11A adjusts the positions of the nozzle 118 relative to the base substrate 1a in the X axis and Y axis directions. After the nozzles 118 reached the positions corresponding to the target regions of the base substrate 1a, the discharger 11A discharges droplets of the insulating material 21A from the nozzles 118. Here, the insulating material 21A is a liquid material containing a polyimide precursor and a solvent. The discharged droplets of the insulating material 21A land on the target regions of the base substrate 1a and form the insulating material layer 21B on the target regions of the base substrate 1a.

The insulating material layer 21B is then activated. In this embodiment, the base substrate 1a is placed in the oven 11B, and the insulating material layer 21B is heated to cure the polyimide precursor, thereby obtaining a polyimide layer. As a result of the activation, the insulating layer 21 (polyimide layer) is formed on the base substrate 1a, as shown in FIG. 10B.

(H2. Intermediate Layer and Conductive Layer)

After the formation of the insulating layer 21, an intermediate layer 51 and the conductive layer 91 having the shape of the conductive pattern 40 (see FIG. 7D) are formed. Here, the conductive layer 91 is stacked on the intermediate layer 51.

In detail, as shown in FIG. 10C, the base substrate 1a having the insulating layer 21 is placed on the stage 106 of the discharger 12A. The discharger 12A then forms an intermediate material layer 51B on the insulating layer 21 based on second bitmap data.

To be more specific, the discharger 12A adjusts the positions of the nozzles 118 relative to the base substrate 1a in the X axis and Y axis directions. After the nozzles 118 reached the positions corresponding to the conductive pattern 40, the discharger 12A discharges droplets of the intermediate material 51A from the nozzles 118. Here, the intermediate material 51A is a liquid material containing a polyimide precursor, a solvent, and silica particles having an average diameter of about 50 nm. The discharged droplets of the intermediate material 51A land on the target regions of the insulating layer 21 to form the intermediate material layer 51B on the target regions of the insulating layer 21, as shown in FIG. 10D. In this manner, the surface of the intermediate material layer 51B containing the silica particles has irregularities of about 50 nm due to the presence of the silica particles.

After the formation of the intermediate material layer 51B, the conductive material layer 91B having the shape of the conductive pattern 40 is formed. In order to do so, the base substrate 1a is taken up on the reel W1 together with a spacer for protecting the intermediate material layer 51B. The reel W1 carrying the base substrate 1a is mounted to a layer-forming apparatus including the discharger 13A. In this embodiment, the oven 12B is not used. Thus, the intermediate material layer 51B is not completely cured.

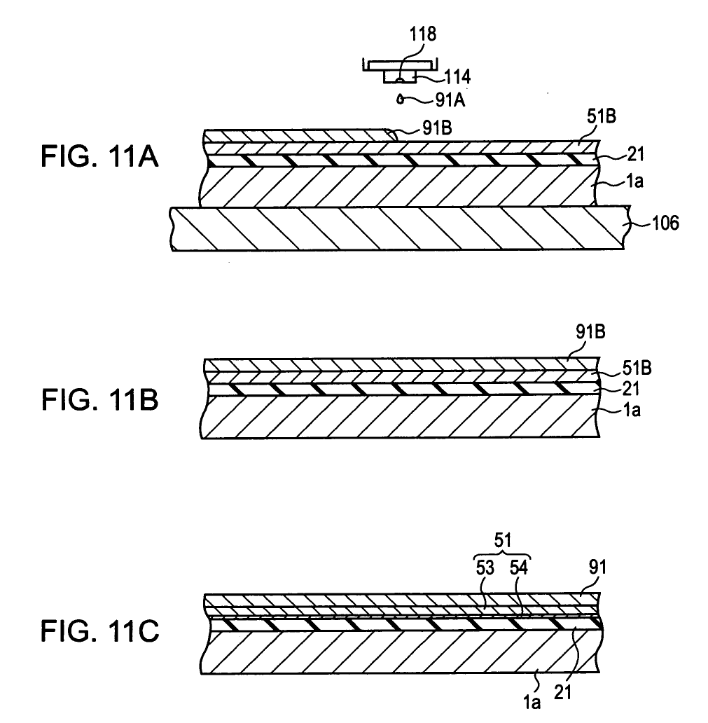

In detail, as shown in FIG. 11A, the base substrate 1a with the intermediate material layer 51B is placed on the stage 106 of the discharger 13A. The discharger 13A then forms the conductive material layer 91B on the intermediate material layer 51B based on third bitmap data.

To be more specific, the discharger 13A adjusts the positions of the nozzles 118 relative to the base substrate 1a in the X axis and Y axis directions. After the nozzles 118 reached the positions corresponding to the conductive pattern 40, the discharger 13A discharges droplets of the conductive material 91A from the nozzles 118. The discharged droplets of the conductive material 91A land on the intermediate material layer 51B and form the conductive material layer 91B on the intermediate material layer 51B, as shown in FIG. 11B.

As is described above, the average diameter of the silver particles is about 10 nm. That is, the average diameter of the silver particles is smaller than the irregularities in the surface of the intermediate material layer 51B. Thus, the silver particles in the conductive material layer 91B enter the irregularities in the surface of the intermediate material layer 51B.

After the formation of the conductive material layer 91B, the intermediate material layer 51B and the conductive material layer 91B are activated. In this embodiment, the base substrate 1a is placed in the oven 13B. The intermediate material layer 51B and the conductive material layer 91B are heated to obtain the intermediate layer 51 and the conductive layer 91 tightly adhering to each other, as shown in FIG. 11C. The intermediate layer 51 is constituted from a buffer sublayer 53 and a connection sublayer 54, as described below.

In detail, the activation of the intermediate material layer 51B and the conductive material layer 91B allows the polyimide precursor in the intermediate material layer 51B to cure, and the buffer sublayer 53 is produced from the intermediate material layer 51B as a result. Moreover, the silver particles in the conductive material 91A become sintered or melt-bonded to form the conductive layer 91 from the conductive material layer 91B. Since silver particles lie in the irregularities in the surface of the intermediate material layer 51B, the intermediate layer 51 is tightly bonded to the conductive layer 91 due to anchor curing.

As a result of the activation, the polyimide in the surface of the insulating layer 21 combines with the polyimide precursor in the other surface of the intermediate material layer 51B, thereby forming the connection sublayer 54 between the insulating layer 21 and the buffer sublayer 53. Thus, the insulating layer 21 is tightly bonded to the buffer sublayer 53 with the connection sublayer 54 therebetween. Note that the polyimide in the insulating layer 21 and the polyimide in the intermediate layer 51 formed by the activation correspond to the “insulating resin” of the invention.

Thus, the intermediate layer 51 tightly bonds to both the insulating layer 21 and the conductive layer 91. Compared to a structure that has no intermediate layer 51, the separation of the conductive layer 91 becomes less frequent.

The insulating resin in the insulating layer 21 may be different from the insulating resin contained in the intermediate layer 51 if the linear expansion coefficient of the insulating resin in the insulating layer 21 is equal or close to that of the insulating resin in the intermediate layer 51.

### Fourth Embodiment

A method for making layers according to a fourth embodiment will now be described. The method of this embodiment is basically the same as the method of the first embodiment except that the insulating material 22A and the intermediate material 61A are used instead of the insulating material 21A and the intermediate material 31A, respectively.

(I1. Insulating Layer)

The insulating layer 22 composed of an inorganic insulator is formed on the base substrate 1a. In particular, as shown in FIG. 12A, the base substrate 1a is placed on the stage 106 of the discharger 11A. The discharger 11A forms the insulating material layer 22B on the base substrate 1a based on first bitmap data. The insulating material layer 22B substantially completely covers one of the surfaces of the base substrate 1a. In other words, the insulating material layer 22B is a fully overlaying layer.

In detail, the discharger 11A adjusts the positions of the nozzles 118 relative to the base substrate 1a in the X axis and Y axis directions. After the nozzles 118 reached the target regions of the base substrate 1a, the discharger 11A discharges droplets of the insulating material 22A from the nozzles 118. Here, the insulating material 22A is a liquid material containing an inorganic insulator and a solvent. The discharged droplets of the insulating material 22A land on the target regions of the base substrate 1a and form the insulating material layer 22B on the target regions of the base substrate 1a.

The insulating material layer 22B is then activated. In this embodiment, the base substrate 1a is placed in the oven 11B. The insulating material layer 22B is heated to evaporate the solvent in the insulating material layer 22B and to precipitate or melt-bond the inorganic insulator. As a result of the activation, the insulating layer 22 is formed on the base substrate 1a, as shown in FIG. 12B.

(I2. Intermediate Layer and Conductive Layer)

After the formation of the insulating layer 22, an intermediate layer 61 and the conductive layer 91 having the shape of the conductive pattern 40 (see FIG. 7D) are formed. Here, the conductive layer 91 is stacked on the intermediate layer 61.

In detail, as shown in FIG. 12C, the base substrate 1a with the insulating layer 22 is placed on the stage 106 of the discharger 12A. The discharger 12A forms an intermediate material layer 61B on the insulating layer 22 based on second bitmap data.

To be more specific, the discharger 12A adjusts the positions of the nozzles 118 relative to the base substrate 1a in the X axis and Y axis directions. After the nozzles 118 reached the positions corresponding to the conductive pattern 40, the discharger 12A discharges droplets of the intermediate material 61A from the nozzles 118. Here, the intermediate material 61A is a liquid material containing an inorganic insulator, a solvent, and silica particles having an average diameter of about 50 nm. The discharged droplets of the intermediate material 61A land on the target regions of the insulating layer 22 to form the intermediate material layer 61B on the target regions of the insulating layer 22, as shown in FIG. 12D. Here, the surface of the intermediate material layer 61B has irregularities of about 50 nm due to the presence of the silica particles.

After the formation of the intermediate material layer 61B, the conductive material layer 91B having the shape of the conductive pattern 40 is formed. In order to do so, the base substrate 1a is taken up on the reel W1 together with a spacer for protecting the intermediate material layer 61B. The reel W1 carrying the base substrate 1a is mounted to a layer-forming apparatus including the discharger 13A. In this embodiment, the oven 12B is not used. Thus, the intermediate material layer 61B is not completely cured.

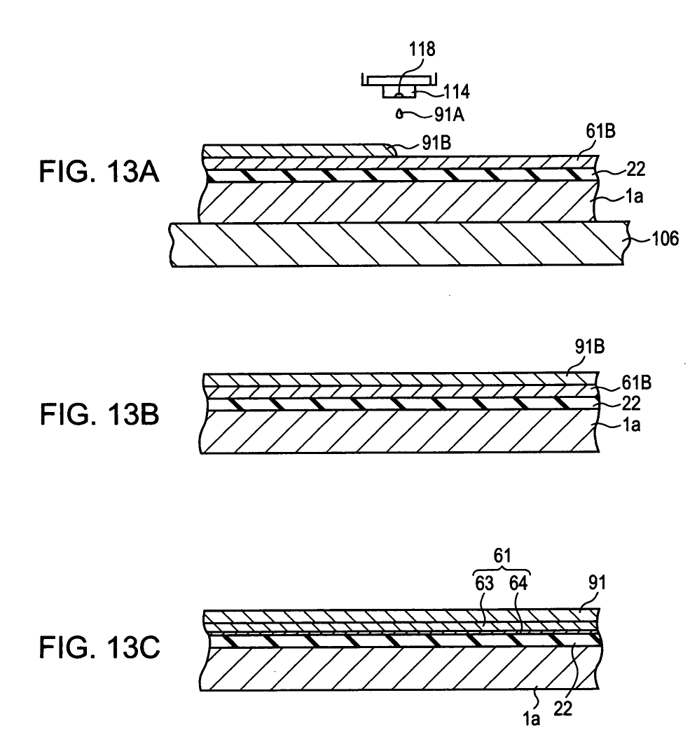

In particular, as shown in FIG. 13A, the base substrate 1a with the intermediate material layer 61B is placed on the stage 106 of the discharger 13A. The discharger 13A then forms the conductive material layer 91B on the intermediate material layer 61B based on third bitmap data.

In detail, the discharger 13A adjusts the positions of the nozzles 118 relative to the base substrate 1a in the X axis and Y axis directions. After the nozzles 118 reached the positions corresponding to the conductive pattern 40, the discharger 13A discharges droplets of the conductive material 91A from the nozzles 118. The discharged droplets of the conductive material 91A land on the intermediate material layer 61B to form the conductive material layer 91B on the intermediate material layer 61B, as shown in FIG. 13B.

As is previously described, the average diameter of the silver particles is about 10 nm and is smaller than the irregularities in the surface of the intermediate material layer 61B. Thus, the silver particles in the conductive material layer 91B enter the irregularities in the surface of the intermediate material layer 61B.

After the formation of the conductive material layer 91B, the intermediate material layer 61B and the conductive material layer 91B are activated. In this embodiment, the base substrate 1a is placed in the oven 13B. The intermediate material layer 61B and the conductive material layer 91B are heated to form the intermediate layer 61 and the conductive layer 91 tightly bonded to each other, as shown in FIG. 13C. The intermediate layer 61 is constituted from a buffer sublayer 63 and a connection sublayer 64.

In detail, the activation of the intermediate material layer 61B and the conductive material layer 91B causes the inorganic insulator in the intermediate material layer 61B to precipitate or melt-bond, thereby forming the buffer sublayer 63 from the intermediate material layer 61B. Moreover, the silver particles of the conductive material 91A become sintered or melt-bonded to form the conductive layer 91 from the conductive material layer 91B. Since the silver particles lie in the irregularities in the surface of the intermediate material layer 61B, the intermediate layer 61 and the conductive layer 91 are tightly bonded to each other by anchor curing.

As a result of the activation, the inorganic insulator in the surface of the insulating layer 22 combines with the inorganic insulator in the other surface of the intermediate material layer 61B to form the connection sublayer 64 between the insulating layer 22 and the buffer sublayer 63. Thus, the insulating layer 22 and the buffer sublayer 63 are tightly bonded to each other with the connection sublayer 64 therebetween.

The intermediate layer 61 thus bonds to both the insulating layer 22 and the conductive layer 91. Thus, separation of the conductive layer 91 is less frequent compared to the structure having no intermediate layer 61.

The inorganic insulator in the insulating layer 22 may be different from the inorganic insulator in the intermediate layer 61 if the linear expansion coefficient of the inorganic insulator in the insulating layer 22 is equal or close to that of the inorganic insulator in the intermediate layer 61.

### Fifth Embodiment

A method for making layers according to a fifth embodiment will now be described. The method of this embodiment is basically the same as the method of the first embodiment except that the intermediate material 71A is used instead of the intermediate material 31A and that the discharger 12A and the discharger 13A are aligned in series between the pair of the reels W1.

(J1. Insulating layer)

The insulating layer 21 composed of an insulating resin is first formed on the base substrate 1a. In particular, as shown in FIG. 14A, the base substrate 1a is placed on the stage 106 of the discharger 11A. The discharger 11A forms the insulating material layer 21B on the base substrate 1a based on first bitmap data. The insulating material layer 21B substantially completely covers one of the surfaces of the base substrate 1a. In other words, the insulating material layer 21B is a fully overlaying layer.

In detail, the base substrate 1a adjusts the positions of the nozzles 118 relative to the base substrate 1a in the X axis and Y axis directions. After the nozzles 118 reached the target regions of the base substrate 1a, the discharger 11A discharges droplets of the insulating material 21A from the nozzles 118. Here, the insulating material 21A is a liquid material containing a polyimide precursor and a solvent. The discharged droplets of the insulating material 21A land on the target regions of the base substrate 1a and form the insulating material layer 21B on the target regions of the base substrate 1a.

The insulating material layer 21B is then activated. In this embodiment, the base substrate 1a is placed in the oven 11B. The insulating material layer 21B is heated to allow the polyimide precursor in the insulating material layer 21B to cure, thereby producing a polyimide layer. As a result of the activation, the insulating layer 21 (polyimide layer) is formed on the base substrate 1a, as shown in FIG. 14B.

(J2. Intermediate Layer and Conductive Layer)

After the formation of the insulating layer 21, an intermediate layer 71 and the conductive layer 91 both having the shape of the conductive pattern 40 (see FIG. 7D) are formed. Here, the conductive layer 91 is stacked on the intermediate layer 71.

In detail, as shown in FIG. 14C, the base substrate 1a with the insulating layer 21 is placed on the stage 106 of the discharger 12A. The discharger 12A then forms an intermediate material layer 71B on the insulating layer 21 based on second bitmap data.

To be more specific, the discharger 12A adjusts the positions of the nozzles 118 relative to the base substrate 1a in the X axis and Y axis directions. After the nozzles 118 reached the positions corresponding to the specific pattern, the discharger 12A discharges droplets of the intermediate material 71A from the nozzles 118. Here, the intermediate material 71A is a liquid material containing a polyimide precursor and a solvent. The discharged droplets of the intermediate material 71A land on the target regions of the insulating layer 21 to form the intermediate material layer 71B on the target regions of the insulating layer 21, as shown in FIG. 14D. Note that the intermediate material 71A is the same as the intermediate material 31A in the first embodiment except that the intermediate material 71A does not contain silver particles.

After the formation of the intermediate material layer 71B, the conductive material layer 91B having the shape of the conductive pattern 40 is formed.

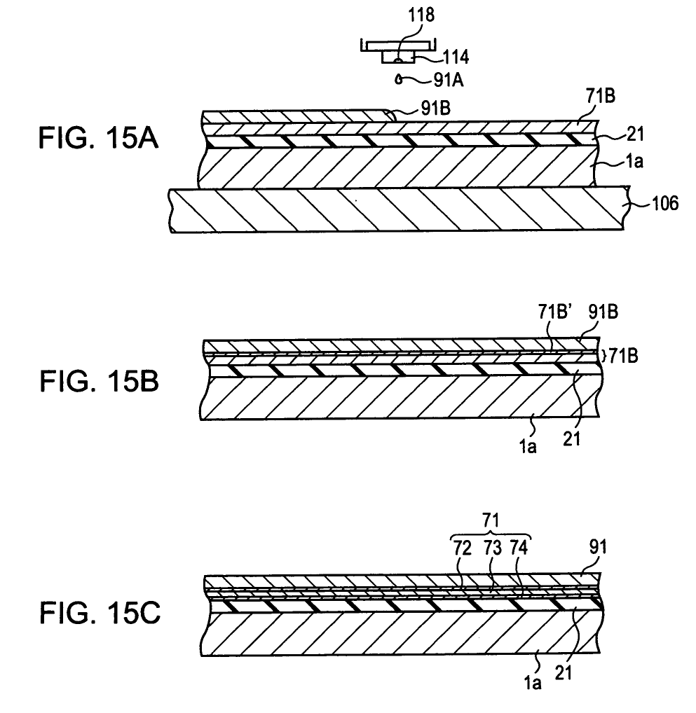

In detail, as shown in FIG. 15A, the base substrate 1a with the intermediate material layer 71B is placed on the stage 106 of the discharger 13A before the intermediate material layer 71B substantially loses its flowability. The discharger 13A then forms the conductive material layer 91B on the intermediate material layer 71B based on third bitmap data. In this embodiment, the discharger 12A is connected to discharger 13A in series between the pair of the reels W1.

To be more specific, the discharger 13A adjusts the positions of the nozzles 118 relative to the base substrate 1a in the X axis and Y axis directions. After the nozzles 118 reached the positions corresponding to the predetermined pattern, the discharger 13A discharges droplets of the conductive material 91A from the nozzles 118. The discharged droplets of the conductive material 91A land on the intermediate material layer 71B to form the conductive material layer 91B on the intermediate material layer 71B, as shown in FIG. 15B.

In this process, the conductive material 91A ejected from the discharger 13A lands on the intermediate material layer 71B before the intermediate material layer 71B substantially loses flowability. Thus, as shown in FIG. 15B, a mixed layer 71B containing silver particles derived from the conductive material 91A is formed on the top of the intermediate material layer 71B.

After the formation of the conductive material layer 91B, the intermediate material layer 71B and the conductive material layer 91B are activated. In this embodiment, the base substrate 1a is placed in the oven 13B, and the intermediate material layer 71B and the conductive material layer 91B are heated to obtain the intermediate layer 71 and the conductive layer 91 tightly bonded to each other, as shown in FIG. 15C. Note that the intermediate layer 71 is constituted from a first connection sublayer 72, a buffer sublayer 73, and a second connection sublayer 74, as described below.

In detail, the activation of the intermediate material layer 71B and the conductive material layer 91B causes the polyimide precursor in the intermediate material layer 71B to cure, thereby producing the buffer sublayer 73 from the intermediate material layer 71B. At the same time, the silver particles in the conductive material layer 91B become sintered or melt-bonded to produce the conductive layer 91 from the conductive material layer 91B. Meanwhile, the silver particles in the surface layer (the mixed layer 71B′) of the intermediate material layer 71B become sintered or melt-bonded to form the first connection sublayer 72 between the buffer sublayer 73 and the conductive layer 91. As a result, the buffer sublayer 73 is bonded to the conductive layer 91 with the first connection sublayer 72 therebetween.

Furthermore, the activation causes the polyimide in the surface of the insulating layer 21 to combine with the polyimide precursor in the other surface of the intermediate material layer 71B, thereby forming the second connection sublayer 74 between the insulating layer 21 and the buffer sublayer 73. As a result, the insulating layer 21 bonds to the buffer sublayer 73 via the second connection sublayer 74. Note that the polyimide in the insulating layer 21 and the polyimide in the intermediate layer 71 formed by the activation correspond to the “insulating resin” of the invention.

Accordingly, the intermediate layer 71 can tightly bond to both the insulating layer 21 and the conductive layer 91. The intermediate layer 71 contains an insulating resin and the silver particles derived from the conductive material layer 91B. In other words, the intermediate layer 71 contains the same insulating resin as the insulating layer 21, and the same metal as the conductive layer 91. Thus, the linear expansion coefficient of the intermediate layer 71 comes between the linear expansion coefficient of the insulating layer 21 and the linear expansion coefficient of the conductive layer 91. Thus, compared to a structure that has no intermediate layer 71, the stress generated when the insulating layer 21 undergoes thermal expansion is small. Thus, separation of the conductive layer 91 due to thermal expansion is less frequent compared to the structure that has no intermediate layer 71.

The insulating resin in the insulating layer 21 may be different from the insulting layer in the intermediate layer 71 if the linear expansion coefficient of the insulating resin in the insulating layer 21 is equal or close to the linear expansion coefficient of the insulating resin in the resulting intermediate layer 71.

### Sixth Embodiment

Next, a method of making layers according to a sixth embodiment will be described. The method of this embodiment is basically the same as the method of the first embodiment except that the insulating material 22A and the intermediate material 81A are used instead of the insulating material 21A and the intermediate material 31A, respectively, and that the discharger 12A and the discharger 13A are connected in series between the pair of the reels W1.

(K1. Insulating Layer)

The insulating layer 22 composed of an inorganic insulator is formed on the base substrate 1a. In particular, as shown in FIG. 16A, the base substrate 1a is placed on the stage 106 of the discharger 11A. The discharger 11A forms the insulating material layer 22B on the base substrate 1a based on the first bitmap data. The insulating material layer 22B substantially completely covers one of the surfaces of the base substrate 1a. In other words, the insulating material layer 22B is a fully overlaying layer.

In detail, the discharger 11A adjusts the positions of the nozzles 118 relative to the base substrate 1a in the X axis and Y axis directions. After the nozzles 118 reached the positions corresponding to the target regions of the base substrate 1a, the discharger 11A discharges droplets of the insulating material 22A from the nozzles 118. The insulating material 22A is a liquid material containing an inorganic insulator and a solvent. The discharged droplets of the insulating material 22A land on the target regions of the base substrate 1a to form an insulating material layer 22B on the target regions of the base substrate 1a.

The insulating material layer 22B is then activated. In this embodiment, the base substrate 1a is placed in the oven 11B, and the insulating material layer 22B is heated to evaporate the solvent in the insulating material layer 22B and to precipitate or melt-bond the inorganic insulator. As a result of the activation, the insulating layer 22 is formed on the base substrate 1a, as shown in FIG. 16B.

(K2. Intermediate Layer and Conductive Layer)

After the formation of the insulating layer 22, an intermediate layer 81 and the conductive layer 91 both having the shape of the conductive pattern 40 (see FIG. 7D) are formed. Here, the conductive layer 91 is stacked on the intermediate layer 81.

In particular, as shown in FIG. 16C, the base substrate 1a with the insulating layer 22 is placed on the stage 106 of the discharger 12A. The discharger 12A then forms an intermediate material layer 81B on the insulating layer 22 based on second bitmap data.

To be more specific, the discharger 12A adjusts the positions of the nozzles 118 relative to the base substrate 1a in the X and Y axis directions. After the nozzles 118 reached the positions corresponding to the conductive pattern 40, the discharger 12A discharges droplets of the intermediate material 81A from the nozzles 118. Here, the intermediate material 81A contains an inorganic insulator and a solvent. The discharged droplets of the intermediate material 81A land on the target regions of the insulating layer 22 and form the intermediate material layer 81B on the target regions of the insulating layer 22, a shown in FIG. 16D. Note that the intermediate material 81A in this embodiment is the same as the insulating material 22A.

After the formation of the intermediate material layer 81B, the conductive material 91A having the shape of the conductive pattern 40 is formed.

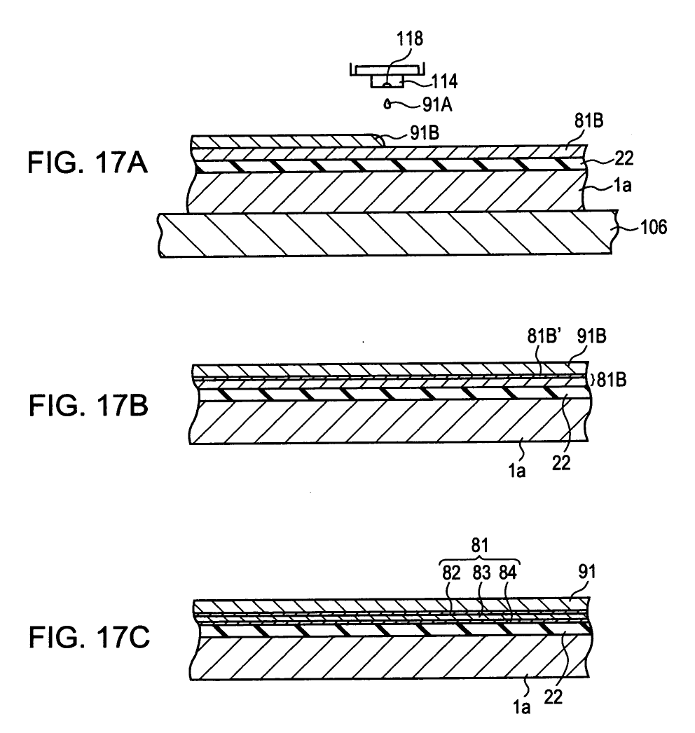

In detail, as shown in FIG. 17A, the base substrate 1a with the intermediate material layer 81B is placed on the stage 106 of the discharger 13A before the intermediate material layer 81B substantially loses flowability. The discharger 13A then forms the conductive material layer 91B on the intermediate material layer 81B based on third bitmap data. Note that in this embodiment, the discharger 12A is connected to the discharger 13A in series between the pair of reels W1.

To be more specific, the discharger 13A adjusts the positions of the nozzles 118 relative to the base substrate 1a in the X axis and Y axis directions. After the nozzles 118 reached the positions corresponding to a specific pattern, the discharger 13A discharges droplets of the intermediate material 91A from the nozzles 118. The discharged droplets of the intermediate material 91A land on the intermediate material layer 81B to form the intermediate material layer 91B on the target regions of the intermediate material layer 81B, as shown in FIG. 17B.

The conductive material 91A discharged from the discharger 13A land on the intermediate material layer 81B before the intermediate material layer 81B substantially loses its flowability. Thus, as shown in FIG. 17B, a mixed layer 81B′ containing the silver particles derived from the conductive material 91A is formed at the top of the intermediate material layer 81B.

After the formation of the conductive material layer 91B, the intermediate material layer 81B and the conductive material layer 91B are activated. In this embodiment, the base substrate 1a is placed in the oven 13B, and the intermediate material layer 81B and the conductive material layer 91B are heated to form the intermediate layer 81 and the conductive layer 91 tightly bonded to each other, as shown in FIG. 17C. Note that the intermediate layer 81 is constituted from a first connection sublayer 82, a buffer sublayer 83, and a second connection sublayer 84, as described below.

In detail, the activation of the intermediate material layer 81B and the conductive material layer 91B causes the inorganic insulator in the intermediate material layer 81B to precipitate or melt-bond, thereby forming the buffer sublayer 83 from the intermediate material layer 81B. The silver particles of the conductive material layer 91B become sintered or melt-bonded to form the conductive layer 91 in the conductive material layer 91B. At the same time, the silver particles in the surface layer (mixed layer 81B′) of the intermediate material layer 81B sinters or melt-bond to silver particles in the surface layer of the conductive material layer 91B, thereby forming the first connection sublayer 82 between the buffer sublayer 83 and the conductive layer 91. As a result, the buffer sublayer 83 tightly bonds to the conductive layer 91 with the first connection sublayer 82 therebetween.

Meanwhile, the inorganic insulator in the surface of the insulating layer 22 combines with the inorganic insulator in the other surface of the intermediate material layer 81B to form the second connection sublayer 84 between the insulating layer 22 and the buffer sublayer 83. As a result, the insulating layer 22 tightly bonds to the buffer sublayer 83 with the second connection sublayer 84 therebetween.

In this manner, the intermediate layer 81 can bond to both the insulating layer 22 and the conductive layer 91. Moreover, the intermediate layer 81 contains the inorganic insulator and the silver particles derived from the conductive material layer 91B. In other words, the intermediate layer 81 contains the same inorganic insulator as the insulating layer 22 and the same metal as the conductive layer 91. Thus, the linear expansion coefficient of the intermediate layer 81 comes between the linear expansion coefficient of the insulating layer 22 and the linear expansion coefficient of the conductive layer 91. Thus, compared to a structure that has no intermediate layer 81, the stress generated by thermal expansion of the insulating layer 22 is low. Thus, separation of the conductive layer 91 due to thermal expansion is less frequent compared to the structure having no intermediate layer 81.

Note that the inorganic insulator in the insulating layer 22 may be different from the inorganic insulator in the intermediate layer 81 if the linear expansion coefficient of the inorganic insulator in the insulating layer 22 is equal or close to the linear expansion coefficient of the inorganic insulator contained in the intermediate layer 81.

As is described above, wiring boards having conductive layers not easily separable from the base can be formed by inkjet techniques according to the above first to sixth embodiments. An example of the wiring board is a substrate connected to a liquid crystal panel of a liquid crystal display. The methods for forming layers according to these embodiments can be applied to the manufacture of the liquid crystal displays.

The methods of these embodiments can be applied to the manufacture of other electrooptic devices than liquid crystal displays. The term “electrooptic devices” refers to all devices that can emit, transmit, or reflect light in response to application of signal voltage and is therefore not limited to those devices that utilize changes in optical characteristics, such as changes in birefringence, optical rotation, and optical scattering property, i.e., “electro-optical effect”.

In particular, the term “electrooptic devices” includes liquid crystal displays, electroluminescence displays, plasma displays, surface-conduction electron-emitter displays (SEDs), and field emission displays (FEDs).

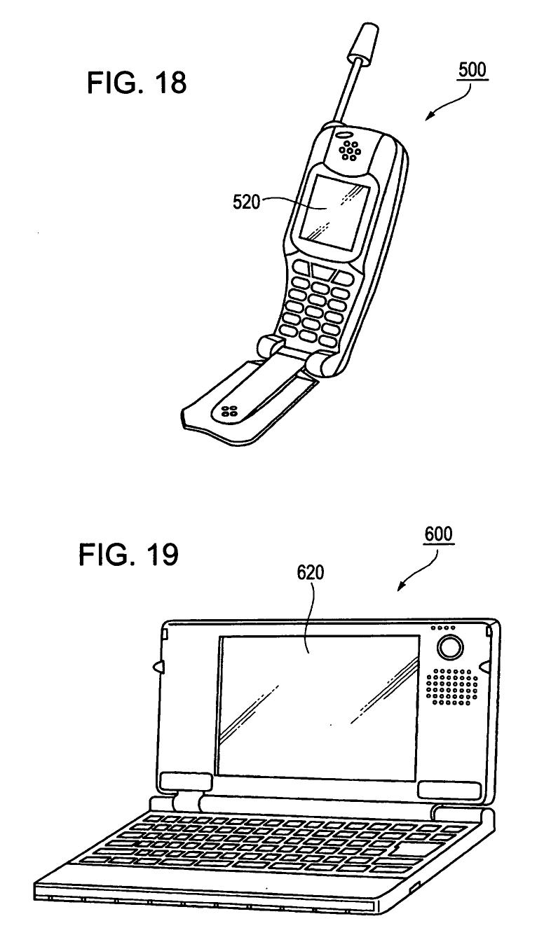

The methods of the first and sixth embodiments described above may be applied to methods for producing various electronic devices. For example, they may be applied to methods for making a cellular phone 500 having a liquid crystal display 520 shown in FIG. 18 or to methods for making a personal computer 600 having a liquid crystal display 620 shown in FIG. 19.

(Modification 1)

In the first to sixth embodiments above, a conductive wiring is formed on the base substrate 1a composed of a polyimide. Instead of such a base substrate 1a, substrates composed of ceramic, glass, epoxy, glass epoxy, or silicon may be used. The same advantages can still be achieved with these substrates. When a silicon substrate is used, a passivation film may be formed on the surface of the substrate prior to discharging a conductive material. Regardless of the type of substrate or layer, the region where the liquid material 111 discharged from the nozzles 118 land on corresponds to the “target region”.

(Modification 2)

The conductive layer 91 of the first to sixth embodiments contains silver nanoparticles. The silver nanoparticles may be replaced with nanoparticles of other metals. Examples of such metals include gold, platinum, copper, palladium, rhodium, osmium, ruthenium, iridium, iron, tin, zinc, cobalt, nickel, chromium, titanium, tantalum, tungsten, indium, and alloys of these. Silver, which can be reduced at relatively low temperatures, is easy to handle. Thus, a conductive material 91A containing silver nanoparticles is preferred in the inkjet technique.

In the first to fourth embodiments, the conductive material 91A may contain an organometal compound instead of metal nanoparticles. The organometal compound here is a compound that precipitates metal by pyrolysis, i.e., activation. Examples of the organometal compound include chlorotriethylphosphine gold(I), chlorotrimethylphosphine gold(I), chlorotriphenylphosphine gold(I), a 2,4-pentanedionato silver(I) complex, a trimethylphosphine(hexafluoroacetylacetonato) silver(I) complex, and a hexafluoropentanedionatocyclooctadiene copper(I) complex.

The form of the metal contained in the conductive material 91A may be particles, such as nanoparticles, or a compound, such as an organometal compound.

(Modification 3)

In the above-described first to sixth embodiments, the insulating material layer, the intermediate material layer, and the conductive material layers are supplied or applied to the target regions by inkjet techniques. However, printing techniques, such as screen printing, may be used instead of the inkjet techniques to form these layers.

(Modification 4)

The intermediate layers 31, 41, 51, and 61 and the conductive layer 91 described in the first to fourth embodiments may be made using only one layer-forming apparatus. In detail, the layer-forming apparatuses described in the fifth and sixth embodiments (i.e., the layer-forming apparatuses in which the discharger 12A is connected to the discharger 13A in series) may be used to form these layers.

1. A method for making layers, comprising:
(A) applying or supplying a liquid intermediate material on a first layer composed of a first insulating resin to form an intermediate material layer on the first layer;
(B) applying or supplying a liquid conductive material containing a first metal on the intermediate material layer to form a conductive material layer on the intermediate material layer; and
(C) activating the intermediate material layer and the conductive material layer to form an intermediate layer and a conductive layer on the intermediate layer;
wherein the liquid intermediate material contains a precursor of a second insulating resin and fine particles of a second metal.

2. The method according to claim 1, wherein the first insulating resin and the second insulating resin are the same.

3. The method according to claim 1, wherein the first metal and the second metal are the same.

4. A method for making layers, comprising:
(A) applying or supplying a liquid intermediate material on a first layer composed of an inorganic insulator to form an intermediate material layer on the first layer;
(B) applying or supplying a liquid conductive material containing a first metal on the intermediate material layer to form a conductive material layer on the intermediate material layer; and
(C) activating the intermediate material layer and the conductive material layer to form an intermediate layer and a conductive layer on the intermediate layer;
wherein the liquid intermediate material contains a second inorganic insulator and fine particles of a second metal.

5. The method according to claim 4, wherein the first inorganic insulator and the second inorganic insulator are the same.

6. The method according to claim 4, wherein the first metal and the second metal are the same.

7. A method for making layers, comprising:
(A) applying or supplying a liquid intermediate material on a first layer composed of a first insulating resin to form an intermediate material layer on the first layer;
(B) applying or supplying a liquid conductive material containing a metal on the intermediate material layer to form a conductive material layer on the intermediate material layer; and
(C) activating the intermediate material layer and the conductive material layer to form an intermediate layer and a conductive layer on the intermediate layer,
wherein the liquid intermediate material contains a precursor of a second insulating resin, and fine particles of an inorganic material or a resin.

8. The method according to claim 7, wherein the first insulating resin and the second insulating resin are the same.

9. A method for making layers, comprising:
(A) applying or supplying a liquid intermediate material on a first layer composed of a first inorganic insulator to form an intermediate material layer on the first layer;
(B) applying or supplying a liquid conductive material containing a metal on the intermediate material layer to form a conductive material layer on the intermediate material layer; and
(C) activating the intermediate material layer and the conductive material layer to form an intermediate layer and a conductive layer on the intermediate layer,
wherein the liquid intermediate material contains a second inorganic insulator and fine particles of an inorganic material or a resin.

10. The method according to claim 9, wherein the first inorganic insulator and the second inorganic insulator are the same.

11. The method according to claim 7, wherein, the liquid conductive material contains fine particles of the metal, and
the average diameter of the fine particles of the inorganic material or the resin contained in the liquid intermediate material is larger than the average diameter of the fine particles of the metal contained in the liquid conductive material.

12. A method for making layers, comprising:
(A) applying or supplying a liquid intermediate material on a first layer composed of a first insulating resin to form an intermediate material layer on the first layer;
(B) applying or supplying a liquid conductive material containing fine particles of a metal on the intermediate material layer before the intermediate material layer is completely dried so as to form a conductive material layer on the intermediate material layer; and
(C) activating the intermediate material layer and the conductive material layer to form an intermediate layer and a conductive layer on the intermediate layer,
wherein the liquid intermediate material contains a precursor of a second insulating resin.

13. The method according to claim 12, wherein the first insulating resin and the second insulating resin are the same.

14. A method for making layers, comprising:
(A) applying or supplying a liquid intermediate material on a first layer composed of a first inorganic insulator to form an intermediate material layer on the first layer;
(B) applying or supplying a liquid conductive material containing fine particles of a metal on the intermediate material layer before the intermediate material layer is completely dried to form a conductive material layer on the intermediate material layer; and
(C) activating the intermediate material layer and the conductive material layer to form an intermediate layer and a conductive layer on the intermediate layer,
wherein the liquid intermediate material contains a second inorganic insulator.

15. The method according to claim 14, wherein the first inorganic insulator and the second inorganic insulator are the same.

16. A wiring board made by the method according to claim 1.
